(19) United States
(12) Patent Application Publication
(10) Pub. No.: US 2026/0097637 A1
(43) Pub. Date: Apr. 9, 2026

(54) IMPROVED PLUG-IN HYBRID PROPULSION SYSTEM AND ASSOCIATED VEHICLE

(71) Applicant: EGIDA S.R.L. O, IN FORMA ABBREVIATA, EG S.R.L., Milano (IT)

(72) Inventor: Ermanno BOTTI, Comerio (VA) (IT)

(73) Assignee: EGIDA S.R.L. O, IN FORMA ABBREVIATA, EG S.R.L., Milano (IT)

(21) Appl. No.: 19/114,228

(22) PCT Filed: Sep. 25, 2023
(86) PCT No.: PCT/EP2023/076415

§ 371 Date: Mar. 21, 2025

(30) Foreign Application Priority Data
Sep. 27, 2022 (IT) 102022000019836

(51) Int. Cl. B60K 6/442

(52) U.S. Cl. CPC B60K 6/442

(57) ABSTRACT

The invention concerns a plug-in hybrid propulsion system having an internal combustion engine and an electric motor. The electric motor includes a battery pack having an operating range of between 100 km and 150 km and the internal combustion engine has a displacement of less than or equal to 600 cc. or a power lower than 30-50 hp. The present invention also concerns a related vehicle driven by a plug-in hybrid engine of the aforementioned type.

### FIELD OF APPLICATION

In its more general aspect, the present invention relates to a hybrid propulsion system having specific autonomy characteristics associated with the operation of the thermal and electrical components.

The present invention also concerns a related vehicle comprising such a propulsion system.

The present invention finds application in particular, but not exclusively, in the automotive sector, in particular the automobile sector.

### KNOWN ART

The automotive sector, and in particular the automobile sector, in recent years has increasingly focused on the development of alternative solutions to internal combustion engines, both for ecological reasons and for the problem of the depletion of non-renewable fossil fuel resources.

One of the most developed alternative solutions to date involves the use of electric motors.

There are various types of engines that use different technologies that exploit electricity, and related types of vehicles.

The main categories are “full-electric” vehicles, i.e. vehicles with only electric motors, and “hybrid vehicles”, in which internal combustion engines and electric motors are coupled.

A “full electric” automobile generally has from one to four motors which in turn are made up of a rotor and a stator.

The driving torque of the electric motor is available immediately, even at very low revolutions per minute.

A high-capacity battery pack is added to the vehicles including electric motors.

This pack starts from 35 kWh and goes up allowing to move with ranges starting from around 200 kilometres.

An inverter is also provided which has the task of transforming the direct current output from the batteries into alternating current suitable for the engine.

Electric automobiles are currently more expensive than comparable combustion automobiles.

Furthermore, if the electric motor is very durable, the battery pack is subject to degradation within a few years, and as the charging cycles go by it can lose its storage capacity or ability to withstand the charging cycles.

The charging times of the battery pack depend on the type of charging station (i.e. the electrical power it delivers) and the automobile's battery charger.

Among hybrid automobiles, the simplest type is the so-called “Mild Hybrid Electric Vehicle” (MHEV) , also called light hybrid, in which a small electric unit supports the traditional engine.

The automobile, therefore, is driven only by the combustion engine. In this case, it is a starter/generator that replaces both the alternator and the starter motor. It is connected to the engine with a belt and is not connected in any way to the wheels.

Its purpose is to improve the acceleration at low speeds or allows the so-called “sailing” of the automobile, i.e. the exploitation of inertia for a few meters during slowing down phases.

Another typology is represented by the so-called “Full Hybrid Electrical Vehicle” (FHEV) which features an exclusively gasoline engine and one or more electric units associated with a dedicated battery pack, which allow moving even in electric-only mode for a small amount of kilometers.

In this case, both the electric motor and the internal combustion engine are connected to the traction axle (also called parallel hybrid), even if they never act simultaneously.

The electronics determine the drive of the electric motor depending on the state of charge of the battery and the pressure exerted on the accelerator pedal.

The size of the battery pack is often significant and heavy, around 100 kg; a battery pack that recharges during deceleration and through the combustion engine, which releases part of its energy.

The latest type of hybrid automobile is represented by the so-called “Plug-in Hybrid Electric Vehicle” (PHEV), which has the potential of an electric automobile, but without being tied exclusively to charging stations.

Technically it takes up the operating scheme of the FHEV where the combustion engine is assisted by one or more electric units, but in this case the battery pack is generally larger, increasing the autonomy provided.

Furthermore, the battery pack is not only recharged via the combustion engine or regenerative braking, but it is possible to charge the battery pack directly by accessing a specific external electrical network. For this purpose, columns and wall-boxes, or high-power domestic sockets are typically needed.

Today, long journeys cannot be undertaken based solely on the electric autonomy of a PHEV vehicle, which only guarantees 40 to 65 km in pure electric mode, depending on the models on the market.

In everyday life, however, PHEV can make a difference, provided that the battery pack is previously recharged by drawing on the external electricity grid, for example during the night when the vehicle is parked in the garage.

Otherwise, in fact, the PHEV system would become inefficient compared to the simpler and lighter FVEV, due to the heaviness of the battery pack in the order of 2-300 kilograms.

The theoretical values communicated in relation to the consumption of PHEV vehicles, based on approval tests which among other things evaluate only the fuel and do not at all consider the electricity consumed by discharging the batteries during the test, are in fact only reliable starting from a condition of charged battery.

Nowadays, with the driving habits of the average motorist, PHEVs are used like normal endothermic automobiles, especially if they belong to company fleets and you don't have to pay for fuel. This leads to real consumption values of PHEV vehicles that are much higher than the theoretical data.

In research commissioned by “Transport&Environment”, a European association that brings together non-governmental organizations in the field of transport and the environment and promotes sustainable transport, it was calculated that with the use of a plug-in hybrid automobile with insufficient charge to contribute to traction and therefore with essentially exploitation of the internal combustion engine alone, the emissions are two and a half times higher than what was declared by the manufacturers.

This is obviously linked both to the fact that the PHEV automobile weighs more, given that it has two engines on board, and to the fact that an internal combustion engine of a plug-in hybrid automobile is not optimized for operation without electrical assistance and, in in this case, it consumes more than a corresponding traditional vehicle equipped with only an internal combustion engine.

The need is therefore felt in the present sector to develop a solution that imposes a conscious and more ecological use of a PHEV type automobiles and leads to an optimized exploitation of this technology.

This need is strongly felt in particular with regard to small-displacement vehicles configured for urban use, as they are more tied to everyday life and more subject to incorrect use by motorists who do not regularly recharge and often use the engine alone. endothermic.

A possible known solution provided by the prior art is disclosed in the article by Bernhard Santer: “So fährt das 1-Liter Auto von VW”.

That proposal related a Diesel vehicle having a displacement of 800 cc and a power of 48 hp. The vehicle included a relatively small battery pack with a storage capacity of 5.5 kWh.

The autonomy of that vehicle was about 50 Km under electric power and this is clearly not enough for the purposes that the present disclosure is providing.

An alternative solution is disclosed in the European patent application no EP 2 463 169 A1 relating to a hybrid vehicle wherein the maximum power of the electric machine is greater than the maximum power of the combustion engine. However, that kind of vehicle has a gear arrangement that allows combining the for transmitting mechanical energy from the engine to the electric machine. Therefore, the vehicle uses the combustion engine for charging the battery pack during the driving.

This is not the focus of the present disclosure.

For this reason, the aim of the present invention is to resolve the drawbacks of the prior art.

A further aim is to provide a solution for a PHEV plug-in vehicle improved in particular for small-displacement vehicles or urban vehicles.

Yet another object of the invention is to provide a solution that encourages regular recharging of the vehicle's battery pack, so that this energy source is validly exploited.

Another aim is to exploit efficient technologies in terms of consumption, both as regards the electrical part and the endothermic part of an engine used in a PHEV type vehicle.

Finally, the aim is to provide a solution that is also optimized in terms of production and related costs.

### SUMMARY OF THE INVENTION

The solution idea underlying the present invention is to make the most of the electrical component of a plug-in hybrid automobile but without being totally dependent on it, delegating the endothermic component only to an auxiliary function, without however losing the advantage of having this endothermic component on board.

On the basis of this solution idea, the aforementioned objectives are solved by a plug-in hybrid propulsion system comprising an internal combustion engine and at least one electric motor, in which the at least one electric motor is coupled and powered is coupled and powered by a battery pack; characterized in that said internal combustion engine comprises a displacement less than or equal to 600 cc. and a power between 30-50 hp and wherein said battery pack provides an energy storage capacity less than or equal to 30 kWh.

In essence, it is as if the vehicle of the present invention mainly exploited the electric propulsion mode like a sailboat that exploits the driving force of the wind, but which still has a small thermal engine for maneuverability in port or in the absence of wind. The vehicle of the present invention has an internal combustion engine on board which, however, is used as an auxiliary propulsion force in case of total exhaustion of the electrical charge or to reach the home in case of emergency, or in situations where modest power is required overall thrust. The combustion engine may cooperate with the electric motor to move the vehicle as in hybrid systems; however, it's main purpose is to be used as auxiliary propulsion force in case of need.

Advantageously, this solution allows having a sufficient autonomy for daily urban use, guarantees that in the event of a total discharge it can be reached home or a charging point and expressly requires recharging at the end of the day so as to always operate in the optimized regime for a plug-in hybrid solution.

Advantageously, this solution allows on the one hand to have sufficient energy for use and on the other considers the size and weight of the battery pack.

Still preferably, the internal combustion engine has a displacement less than or equal to 600 cm³, (cc) preferably less than or equal to 500 cm³, even preferably less than or equal to 300 cm³.

Similarly, the internal combustion engine to be used can be identified by the power it is able to deliver and which should be within a range of values between 30 hp and 50 hp.

Advantageously, the present solution guarantees sufficient power for a vehicle designed for urban use, guarantees the autonomy required for the endothermic component, also considering the weight of the endothermic component.

Preferably, in the propulsion system according to the present invention, the electric motor comprises two electric units, a first electric unit acting as an alternator/generator and a second electric unit acting as a thruster.

In this way it is possible to provide three operating modes depending on the driving conditions, namely: a pure electric propulsion when accelerating from a standstill or proceeding at a low cruising speed, a hybrid propulsion in which the internal combustion engine and the electric motor share effort, for example during acceleration at speed and finally engine propulsion when the automobile is powered by the petrol engine in constant high-speed driving conditions. This last condition rarely occurs in the use of the vehicles to which the propulsion system according to the present invention is applied but is nevertheless advantageous.

The propulsion system automatically switches between the three aforementioned modes to optimize operating efficiency. However, a manually forced switch is also provided.

Preferably, the propulsion system in this case comprises a fixed ratio transmission.

Advantageously, it is therefore possible to adopt a relatively small and powerful combustion engine working appropriately at a regime optimized for greater efficiency.

Preferably, the battery pack comprises lithium batteries.

Advantageously, they guarantee a charging efficiency of up to 96% and accept partial charges (so-called “bottle feeding”) and rapid charges.

Still preferably, the internal combustion engine is an Atkinson cycle engine.

Advantageously, this solution is excellent in hybrid systems as the Atkinson cycle has a lower compression ratio than the expansion ratio, leading to a cycle with high thermodynamic efficiency. The low specific power is of little relevance given the intended use of the internal combustion engine in the present invention.

Still preferably, the electric motor is configured for energy recovery during braking.

Advantageously, during breaking the energy, which would otherwise be wasted, is converted into electricity and stored in the battery pack.

Therefore, when braking, the wheels drag and turn the electric motor, producing electricity.

According to a further aspect of the present invention, a vehicle is provided and configured comprising a propulsion system according to the previously disclosed system.

Advantageously, this vehicle is optimized from an operational point of view and encourages correct management of the charging and discharging cycles.

Preferably, such a vehicle has a weight less than or equal to 1000 Kg.

Advantageously, the present solution is optimal for so-called “urban” vehicles, designed for daily urban use.

Further characteristics and advantages of the propulsion system and the related vehicle according to the present invention will result from the description, given below, of a preferred embodiment example given by way of indicative and non-limiting purposes with reference to the attached figures.

### BRIEF DESCRIPTION OF THE FIGURES

FIG. 1 shows a schematic of a hybrid propulsion system and a vehicle according to the present invention;

FIG. 2 shows a schematic of a propulsion system according to a preferred embodiment.

In the different figures, similar elements will be identified by similar reference numbers.

### DETAILED DESCRIPTION

With reference to the attached figures, 1 indicates a propulsion system for a plug-in hybrid vehicle according to the present invention, referred to below for brevity simply as system 1.

System 1 is included within a vehicle 100.

In particular, system 1 includes an internal combustion engine 2 and at least one electric motor 3.

The electric motor 3 is powered by a battery pack 4 having an operating range of between 120 km and 200 km, depending on the overall weight of the vehicle and/or the environmental travelling conditions.

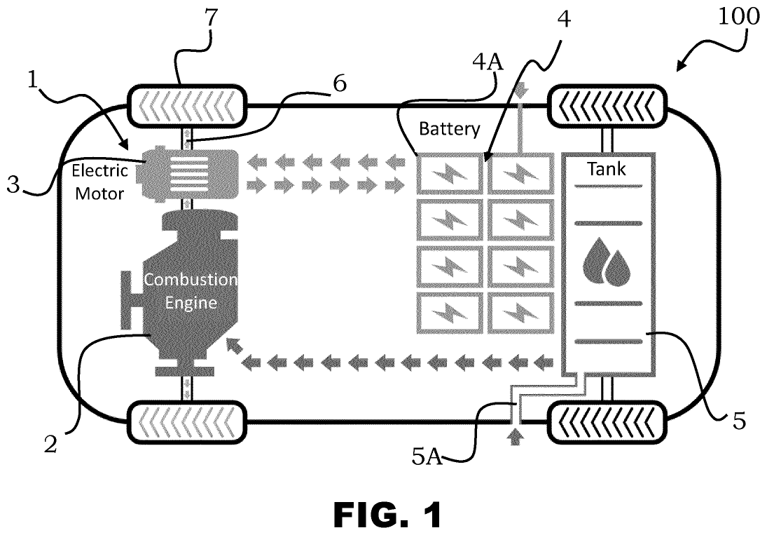

The battery pack 4 includes in the diagram of FIG. 1 a plurality of 4A batteries.

Nothing prevents the battery pack 4 from comprising a single battery or, better yet, a single battery bank which can be completely removable and replaceable.

The battery pack 4 includes lithium batteries, which guarantee a charging efficiency of 96% and accept partial charges and rapid charges.

Nothing would prevent from adopting different types of batteries, also in relation to research and technological development in the sector.

The battery pack 4 provides an energy storage capacity of up to 30 kWh, i.e. less than or equal to 30 kWh, which allows the autonomy required to reach the above operating range also taking into account the dimensions and weight of the battery pack 4 to guarantee this autonomy.

The internal combustion engine 2, in the present embodiment, is preferably an Atkinson cycle engine, i.e. an alternative internal combustion engine similar to the Otto cycle but with a modified crankshaft mechanism so as to obtain greater efficiency at the expense of a decrease in power. The engine is powered by gasoline.

Specifically, the particular geometry of the crank mechanism ensures that the expansion stroke is greater than the compression stroke, thus allowing the engine to have greater efficiency compared to the Otto cycle.

In an alternative embodiment it is possible to adopt an Atkinson cycle rotary engine with a consequent increase in both power and efficiency compared to the Otto cycle.

The internal combustion engine 2 draws from a fuel tank 5 having a capacity less than or equal to 15 liters, fed via a supply pipe 5A.

The adoption of a tank 5 of this size allows on the one hand to always allow the driver to return to his home, in consideration of the predominantly urban use of the vehicle 100, or to reach a charging point when the pack batteries 4 is exhausted. In any case, the relatively limited fuel tank does not allow prolonged use of the internal combustion engine 2 in line with a compatible use of the plug-in hybrid propulsion system 1, with related efficiency and ecological impact.

The internal combustion engine 2 preferably has a displacement less than or equal to 600 cm³ (cc).

This displacement is optimized with respect to the dimensions of the tank 5 to guarantee the vehicle an overall autonomy (i.e. in electric mode and in endothermic mode) of at least 300 km, sufficient in any situation, even outside an urban area, to return to a charging zone.

Nothing prevents us from providing a displacement between 600 and 300 cm³, considering 300 cc. as a conceptual lower limit for an internal combustion engine 2 made for limited use as in the case of the present invention. There is also nothing that would prevent from hypothesizing the use of a motorcycle-type engine, i.e. a two-cylinder and/or two-stroke engine, possibly modified and adapted for the purpose to make it capable of delivering the maximum torque at a number of revolutions lower than 4000 rpm. In this case you could also use an engine with a displacement of less than 300 cc.

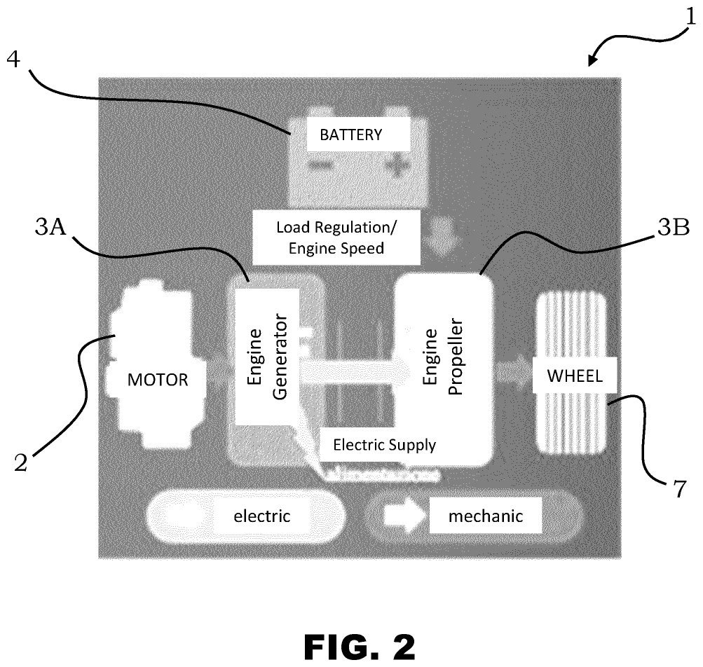

As visible in FIG. 2, in the preferred embodiment of system 1 the electric motor 3 includes two electric units 3A, 3B, a first electric unit 3A acting as an alternator/generator and a second electric unit 3B acting as a thruster.

The electrical units 3A, 3B are connected to each other, to the internal combustion engine 2, to the battery pack 4 and to the axle 6 of the wheels 7.

Thanks to this structure it is possible to experiment with three operating modes depending on the conditions, so as to optimize the use of the electric motor 3 and internal combustion engine 2.

In fact, the internal combustion engine 2 is not very efficient when the vehicle starts from a standstill, when it goes at low speed or when accelerating strongly.

Conversely, the electric motor 3 suffers in conditions of high and constant speed, an ideal condition for the internal combustion engine 2.

Therefore, when starting and accelerating from a standstill or very low speed, system 1 draws energy only from the battery pack 4 and uses pure electric propulsion, so as to guarantee silence and low emissions.

However, when the speed is increased a little or acceleration an acceleration is demanded from an already moving condition, a hybrid propulsion can be exploited with the internal combustion engine 2 which supplies power to the first electric unit 3A acting as an alternator/generator, which in turn powers the second electric unit 3B acting as a propulsion system on the axis 6 of the wheels 7.

In this way, the excess power of the internal combustion engine 2 is used to recharge the battery pack 4 from the first electric unit 3A, and internal combustion engine 2 and electric motor 3 share the effort.

In the case, rare in the typical use of system 1 according to the present invention, of traveling for a short distance at a constant high speed, or during a particularly fast overtaking movement, it is also possible to close a clutch (not shown) to directly operate the wheels 7 with the internal combustion engine 2 and therefore use only this internal combustion engine 2.

The transition from one operating mode to another is managed by a control unit (not shown as it is conventional).

In addition, the system 1 features a sequential automatic transmission. Alternatively, system 1 can provide a fixed ratio transmission, i.e. a direct transmission with a single fixed gear ratio, making the transition from operation totally delegated to the electric motor 3 to hybrid operation with the traction developed simultaneously by the electric motor 3 easy. and internal combustion engine 2 and, possibly, the one solely driven by internal combustion engine 2.

Furthermore, the electric motor 3 is configured for braking energy recovery.

In practice, during braking in the electric motor 3 the rotor induces an electromotive force in the stator, generating electrical energy which is stored in the battery pack 4.

A configuration for braking energy recovery is particularly efficient in system 1 used in an urban context, as frequent starts and stops are expected.

In this way it is possible to improve energy efficiency from 20% up to 30%, depending on the structural and functional characteristics of the electric motor 3, the battery pack 4, as well as, clearly, the user's guidance.

As already mentioned, system 1 with the characteristics illustrated above and as visible in the exemplary diagram in FIG. 1 is installed in a vehicle 100.

In the present embodiment the vehicle 100 has a weight less than or equal to 1000 kg, thus allowing a longer fully electric autonomy.

This weight limit was calculated on the basis of the size of system 1 so as to optimize on the one hand the installation of this system 1 and on the other to optimize performance and consumption, therefore looking at the thrust/weight ratio and the impact of additional weight on autonomy.

Advantageously, the present invention allows for a solution that maintains the advantages guaranteed by hybrid solutions and the duality of operation according to needs, but clearly leaning towards an electric type of operation, delegating only an auxiliary role to the endothermic component and facilitating virtuous behavior of the the user for a correct charging and discharging cycle with optimization of the propulsion system.

To make a comparison with a completely different sector, it is as if the vehicle of the present invention mainly exploited the electric propulsion mode like a sailboat which exploits the driving force of the wind but which has a small thermal engine for maneuverability in port or in the absence of wind. The vehicle of the present invention has an internal combustion engine on board which, however, is used only as an auxiliary propulsion force in case of total exhaustion of the electrical charge or to reach the home in case of emergency, or in a situation in which a particular power is required overall.

Furthermore, a system is advantageously provided for automobiles essentially intended for urban use with technologies suitable for optimal exploitation of both the electrical component and the endothermic component of system 1.

Furthermore, a system is advantageously provided which also provides for an optimization of the weights in relation to the expected operation with a positive impact in terms of consumption and costs.

Finally, advantageously the present system involves the use of highly efficient and robust components, which do not require frequent maintenance interventions.

It will be clear to those skilled in the art that modifications and variations can be made to the propulsion system and the related vehicle according to the present invention, all of which fall within the scope of the attached claims.

For example, nothing prevents the provision of an electric motor with a different configuration compared to the exemplary embodiment described above.

1-14. (canceled)

15. A plug-in hybrid propulsion system comprising an internal combustion engine and an electric motor,
wherein said electric motor is coupled to and powered by a battery pack, wherein said internal combustion engine comprises a displacement of between 600 cm³ and 300 cm³ and a power of between 30-50 hp and wherein said electric motor comprises two electric units, a first electric unit acting as an alternator/generator and a second electric unit acting as a propulsion system and wherein said battery pack provides an energy storage capacity less than or equal to 30 kWh.

16. The plug-in hybrid propulsion system of claim 15 wherein said battery pack allows a fully electric operating autonomy between 120 km and 200 km according to the weight of the vehicle.

17. The plug-in hybrid propulsion system of claim 15, further comprising a fuel tank for powering the internal combustion engine, said fuel tank having a capacity of less than 15 liters.

18. The plug-in hybrid propulsion system of claim 15, wherein said battery pack comprises lithium batteries.

19. The plug-in hybrid propulsion system of claim 15, wherein said internal combustion engine is an Atkinson cycle engine.

20. The plug-in hybrid propulsion system of claim 15, wherein said electric motor is configured for braking energy recovery.

21. A plug-in hybrid vehicle configured with a propulsion system comprising an internal combustion engine and an electric motor,
wherein said electric motor is coupled to and powered by a battery pack, wherein said internal combustion engine comprises a displacement of between 600 cm³ and 300 cm³ and a power of between 30-50 hp and wherein said electric motor comprises two electric units, a first electric unit acting as an alternator/generator and a second electric unit acting as a propulsion system and wherein said battery pack provides an energy storage capacity less than or equal to 30 kWh.

22. The plug-in hybrid vehicle of claim 21, wherein said vehicle has a weight less than or equal to 1000 kg.

23. The plug-in hybrid vehicle of claim 21, wherein the internal combustion engine is an Atkinson cycle engine.

24. The plug-in hybrid vehicle of claim 21, wherein the geometry of the crank mechanism of the engine ensures that the expansion stroke is greater than the compression stroke.

25. The plug-in hybrid vehicle of claim 21, wherein the internal combustion engine is a motorcycle-type engine such as a two-cylinder and/or two-stroke engine, modified and adapted for delivering the maximum torque at a number of revolutions lower than 4000 rpm.

26. The plug-in hybrid vehicle of claim 25, wherein said motorcycle-type engine has a displacement of less than 300 cc.

27. The plug-in hybrid vehicle of claim 21, further comprising a fuel tank for powering the internal combustion engine, said fuel tank having a capacity of less than 15 liters.

28. The plug-in hybrid vehicle of claim 21, wherein said battery pack allows a fully electric operating autonomy between 120 km and 200 km according to the weight of the vehicle.

29. The plug-in hybrid vehicle of claim 21, wherein said electric motor is configured for braking energy recovery.
